(19) United States
(12) Patent Application Publication
(10) Pub. No.: US 2005/0258152 A1
(43) Pub. Date: Nov. 24, 2005

(54) Laser beam machining method

(75) Inventors: Yasunori Kawamoto, Toyota (JP); Fumio Kawanishi, Nukata-gun (JP); Tsuyoshi Hayakawa, Kariya (JP); Yozo Iwai, Kuwana (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya (JP)

(21) Appl. No.: 11/130,337

(22) Filed: May 16, 2005

(30) Foreign Application Priority Data
May 20, 2004 (JP) 2004-150389

(51) Int. Cl. B23K 26/24

(52) U.S. Cl. 219/121.62; 219/121.8

(57) ABSTRACT

In a laser beam machining method in which laser beams L are irradiated with a movement of the robot 3 and the three-dimensional workpiece 10 is machined, a locus speed of the robot 3 at a position where the workpiece 10 is machined is measured previously or in real time, and an intensity of the laser beams is controlled according to this locus speed. In the case of a workpiece made of resin, in addition to the locus speed, a change in the transmission of the workpiece with respect to the laser beams is fed back to an output of the laser beams.

### BACKGROUND OF THE INVENTION

1. Field of the Invention

The present invention relates to a laser beam machining method for welding, cutting and removing metallic material or resin material with a laser beam.

2. Description of the Related Art

A laser beam welding method has been conducted as a joining method for joining metallic material in a non-contact condition at high productivity. In general, the welding speed of laser beam welding is in the range from 1 m/min to 10 m/min, which is higher than the welding speed of arc welding. Further, it is possible to conduct welding in a narrow welding width by the method of laser beam welding. Accordingly, the method of laser beam welding is commonly adopted when a fuel injection injector or an ABS actuator, which require high productivity and accuracy, is manufactured. Concerning the laser beam machining method, in many cases, a method is commonly adopted in which a workpiece is held by a highly accurate rotary jig and rotated under the condition that a unit on the laser beam irradiating side is fixed. In this connection, from the viewpoint of enhancing the productivity, a method has been used for a long time in which a workpiece is fixed and a unit on the laser beam side is circularly moved. Further, a method has been used for a long time in which a large number of workpieces are arranged on tables and machined by laser beams while the workpieces are moved by numerical control (NC).

On the other hand, junction products are known in which a welding technique, using laser beams, is used. The depositing method for depositing resin material by laser beams is described as follows. As resin material having a laser beam absorbing property and a resin material having a laser beam transmitting property are put on each other, and the resin material having the laser beam absorbing property is irradiated with laser beams through the resin material having the laser beam transmitting property, so that the resin material having the laser beam absorbing property can be heated and both materials can be melted and welded. This laser beam welding method for welding the resin materials by laser beams has the following advantages described in items (1) to (3) when it is compared with the conventional welding method in which vibration, ultrasonic waves, heat plates or adhesive is used for weld.

(1) Burr is seldom generated and the joint can be made smaller.

(2) Integrated components are not damaged.

(3) Three-dimensional weld can be made by a robot.

According to this laser beam welding method, it is common that the planes are tightly contacted with each other and a jig, to which a workpiece to be welded is fixed, is driven by numerical control so as to make the deposition of the planes. For example, Japanese Unexamined Patent Publication No. JP-A-5-305464 discloses a machining method in which a laser output corresponding to the previously set machining speed is precisely fitted to the machining speed. However, this method only shows a machining method for machining a two-dimensional shape for cutting a metallic plate two-dimensionally.

On the other hand, the weldment of a material, the shape of which is three-dimensional, is required in many cases. Therefore, it is necessary to quickly establish a welding technique for welding a material, the shape of which is complicated, with a robot. Concerning the prior art, Japanese Unexamined Patent Publication No. JP-A-2003-200280 discloses YAG laser beam welding method in which a robot is used and welding can be excellently performed irrespective of changes in the height of the welding position and the angle of the joining face. On the basis of the welding condition with respect to a horizontal welding portion in which the welding head is directed downward, in the case of “vertical position welding proceeding downward”, in which the welding head is directed upward with respect to the inclined face compared with the perpendicular direction and welding is conducted downward with respect to the inclined face, the welding condition is set in which a quantity of heat of welding is large by a predetermined value by an increase in the laser beam output and/or a decrease in the welding speed. In the case of “vertical position welding proceeding upward”, in which the welding head is directed upward with respect to the inclined face compared with the perpendicular direction and welding is conducted upward with respect to the inclined face, the welding condition is set in which a quantity of heat of welding is small by a predetermined value by a decrease in the laser beam output and/or an increase in the welding speed. In order to set the welding condition as described above, the laser output and the welding speed are changed by the torch angle of the laser beams. It is guessed that the working property is greatly affected by a focal distance and angle in the laser beam machining. However, in the case of laser beam weld of welding resin material with laser beams, the torch angle is not an important factor. When the torch is tilted by an angle not less than 45°, no problems are caused in the quality of weld.

In the case of laser beam weld of welding a three-dimensional complicated shape, depending upon the robot to be used, the locus accuracy and the locus velocity are insufficient in many cases. For example, in the case of welding an air bag sensor three-dimensionally, in a corner portion in which the locus velocity is remarkably reduced, the material is overheated by the laser beams, and problems of the generation of voids are caused. Therefore, it is desired to develop a method of conducting weld flexibly and inexpensively by any robot.

### SUMMARY OF THE INVENTION

The present invention has been accomplished to solve the above problems. It is an object of the present invention to provide a laser beam machining method capable of conducting an excellent weld without causing a problem of defective weld even in the case of welding a three-dimensional shape.

The laser beam machining method of an embodiment of the present invention is a laser beam machining method for machining a workpiece of a three-dimensional shape by irradiating laser beams along a movement of a robot, in which a locus speed of the robot at a position where the workpiece is machined is measured previously or in real time and an output of the laser beams is controlled according to the locus speed. Due to the foregoing, it is possible to prevent the occurrence of such a problem that voids are generated, for example, in a corner portion where the locus speed is remarkably reduced and the corner portion is overheated by laser beams.

In the laser beam machining method of the present invention, the workpiece is a resin product and the machining is weld machining. Therefore, the laser beam machining method is preferably applied to resin products.

In the laser beam machining method of the present invention, a change in the transmission of the resin product with respect to laser beams can be fed back to an output of the laser beams. Due to the foregoing, an appropriate intensity of laser output can be obtained from the speed and transmittance.

In the method of manufacturing a structural body of resin of another embodiment of the present invention, laser beams are irradiated along an irradiation locus, which is set on a surface of the structural body of resin, so as to partially melt the structural body of resin and then the structural body of resin is hardened again, and an output of the laser beams is proportionally controlled according to a locus speed of the laser beams. Due to the foregoing, it is possible to prevent the occurrence of such a problem that voids are generated, for example, in a corner portion where the locus speed is remarkably reduced and the corner portion is overheated by laser beams.

The present invention may be more fully understood from the description of preferred embodiments of the invention, as set forth below, together with the accompanying drawings.

### BRIEF DESCRIPTION OF THE DRAWINGS

In the drawings:

FIG. 1 is an overall arrangement view showing an outline of a laser beam machine for executing a laser beam machining method of an embodiment of the present invention;

FIG. 2A is a graph showing a method of controlling a laser beam output of the present invention;

FIG. 2B is a graph showing a method of controlling a laser beam output of the prior art; and

FIG. 3 is an overall arrangement view showing an outline of another laser beam machine for executing a laser beam machining method of an embodiment of the present invention.

### DESCRIPTION OF THE PREFERRED EMBODIMENTS

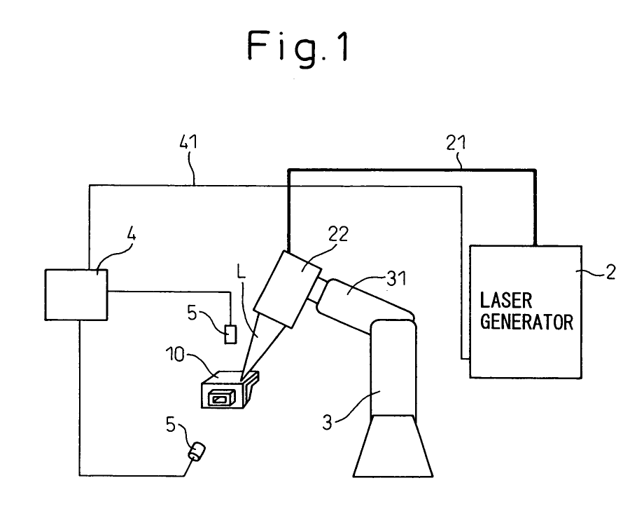

Referring to the accompanying drawings, a laser beam machining method of an embodiment of the present invention will be explained below. FIG. 1 is an overall arrangement view showing an outline of a laser beam machine for executing a laser beam machining method of an embodiment of the present invention. The laser beam machine 1 includes: a laser beam generator 2 for emitting laser beams L; a robot 3 for conducting scanning of the laser beams L; a table (not shown) on which a workpiece 10, which is an object to be machined, is held; a control unit 4 for controlling an output of the laser beams L; and a speed sensor 5 for detecting a locus speed of the robot 3.

Laser beams L emergent from the laser beam generator 2 are transferred through the fibers 21 and condensed by the optical head 22 which is an emergent optical system and then transmitted toward the workpiece 10. The reflecting mirror, the condenser lens and others are arranged in the optical head 22, and the optical head 22 is held by the arm 31 of the robot 3. Accordingly, scanning of laser beams L is conducted when the arm 31 of the robot 3 is moved.

A portion of the workpiece 10 to be machined by laser beams L is formed into a three-dimensional complicated shape. It is preferable that the workpiece 10 is made of resin material, and the laser beam machining is the weld machining. The workpiece 10 is put on the table being fixed by a jig.

In the neighborhood of the workpiece 10, the speed sensor 5 for detecting a scanning speed of laser beams L, which is the same as the speed (the locus speed) of the robot 3, is arranged. For example, in the case of the workpiece 10, the shape of which is three-dimensional, a plurality of speed sensors 5 are three-dimensionally arranged. Data measured by these speed sensors 5 are sent to the control unit 4. In the control unit 4, a calculation is made so that an intensity of laser beams L can become the most appropriate, and the result of the calculation is inputted into the laser generator 2 with the control signal wire 41. Due to the foregoing, laser beams L, the intensity of which is made to be the most appropriate for each locus speed of the robot 3, can be transmitted to the workpiece 10.

In this case, the method of measuring the speed of the robot 3 may be any of the non-contact type position detecting sensor, the image processing sensor and the encoder built in the robot. Alternatively, the method of measuring the speed of the robot 3 may be a method in which laser beams L are transmitted to the workpiece 10, as pulses, at regular intervals and the robot speed is found from the pitch which is marked. In order to calculate the speed data for each portion of the workpiece, it is preferable that the spatial resolution is as high as possible. The locus speed of the robot 3 may be previously measured and stored in the control unit 4. However, the locus speed of the robot 3 may be measured in real time and an output may be controlled according to the stored locus speed of the robot 3.

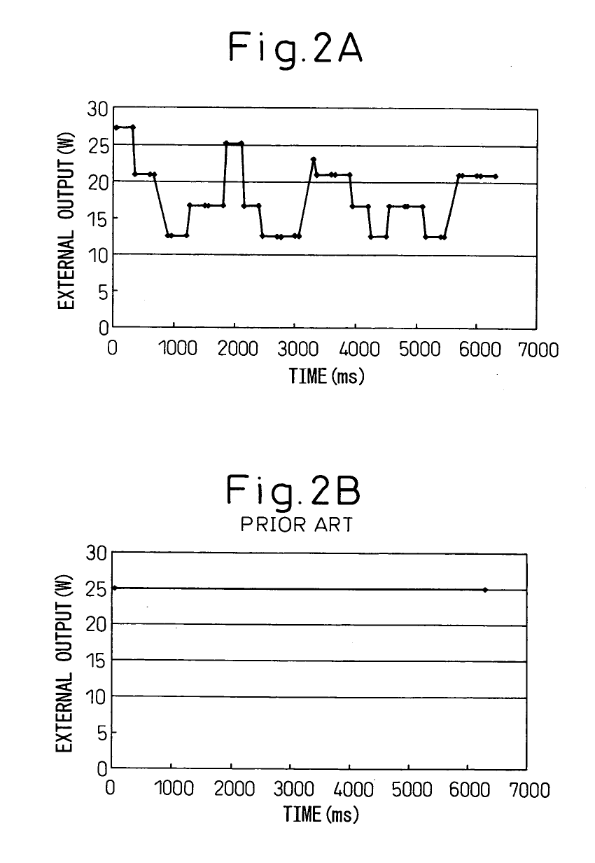

FIG. 2A is a graph showing a method of controlling an output of laser beams in the laser beam machining method of this embodiment, and FIG. 2B is a graph showing a method of controlling an output of laser beams in the laser beam machining method of the prior art. In this case, the axis of ordinates represents the external output W, and the axis of abscissas represents the time ms. According to the prior art, the external output of the laser beams is maintained at a constant value of 25 W. On the other hand, according to this embodiment, the external output of the laser beams is frequently changed in the range from about 27.5 W to about 12 W. This shows that the laser beam output is decreased in a portion of the workpiece 10 to be machined in which the speed of the robot 3 is lowered and that the laser beam output is increased in a portion of the workpiece 10 to be machined in which the speed of the robot 3 is raised. Accordingly, in this embodiment, for example, in a portion such as a corner portion of the workpiece 10 in which the locus speed of the robot 3 is remarkably decreased, overheating caused by the laser beams L can be prevented and a defective join can be avoided.

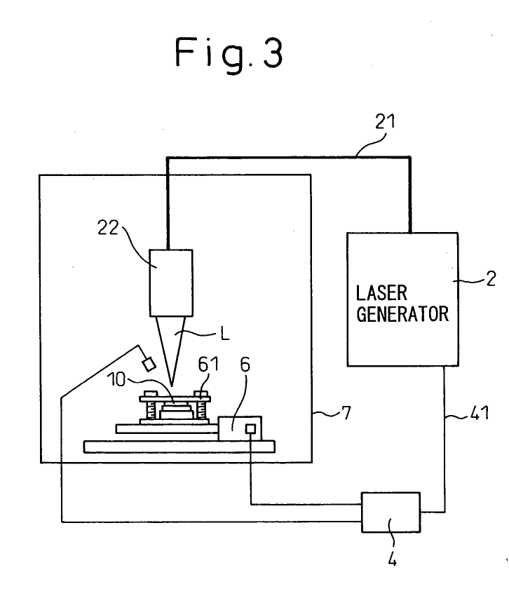

FIG. 3 is an overall arrangement view showing an outline of another laser beam machine for executing a laser beam machining method of an embodiment of the present invention. In the laser beam machine of the embodiment shown in FIG. 1, the shape of the workpiece 10 to be machined is three-dimensional and the workpiece 10 side is fixed and the laser beam irradiation side is moved to be scanned. However, according to the laser beam machining method of this embodiment shown in FIG. 3, the method can be applied to a case in which the shape of the workpiece 10 to be machined is two-dimensional and the laser beam irradiation side is fixed and the workpiece 10 side is moved to be scanned. In FIG. 3, the optical head 22, which is an emergent optical system, is arranged in the machining chamber 7 and fixed, and laser beams L emergent from the laser beam generator 2 and transferred by the optical fibers 21 are transmitted to the workpiece 10. The workpiece 10 to be two-dimensionally machined is fixed to XY table 6 by the jig 61.

The transfer speed of the workpiece 10 is measured by the non-contact type position detecting sensor and the speed sensor 5 such as an encoder built in XY table and sent to the control unit 4. At this time, a calculation is made for the measured data so that an intensity of laser beams L can become the most appropriate intensity of energy, and the result of the calculation is inputted into the laser generator 2 through the control signal wire 41. Due to the foregoing, laser beams, the intensity of which is made to be the most appropriate for each speed, can be irradiated.

In this embodiment, examples of laser beams L used as a heating source are: YAG laser beams, semiconductor laser beams, glass-neodymium laser beams, ruby laser beams, helium-neon laser beams, krypton laser beams, argon laser beams, hydrogen laser beams, nitrogen laser beams and so forth.

The laser machining method of this embodiment can be applied to all laser beam machining such as welding of metal, welding of resin, cutting and removal in which laser beams L are used. However, the laser beam machining method of this embodiment is preferably applied to the welding of resin.

Concerning the workpiece 10, in the case of welding resin with resin products, the following method is effective for enhancing quality of the welding portion. In the case where the transmission of laser beams fluctuates due to the fluctuation of the material composition and also due to the fluctuation of the shot at the time of forming, in addition to the above output control of laser beams conducted by the speed, data of the transmission distribution of the workpiece is previously stored in the control unit 4, and a laser beam output really necessary for the joining interface of the workpiece is found from both the speed and the transmission. In this case, it is preferable that the result of measuring the transmission distribution is transferred to the control unit for each lot or workpiece. If it is possible to conduct it in-line, a laser beam welding system using the robot, the productivity of which is high, can be built.

Further, this embodiment can be applied to all types of machining which use not only energy of laser beams but also energy such as an arc or electron beam in all drive units in which numerical control (NC) and a robot are used. Concerning the arc welding, when the speed is decreased, an excessively large quantity of heat is inputted into the welding portion and it is considered that plasma exists in the welding portion. Therefore, when the size of the plasma is measured, the speed is estimated and the most appropriate arc welding condition is set.

As described above, this embodiment discloses a laser beam machining method or a method for manufacturing a laser beam machined product using the laser beam machine in which a laser beam irradiating point irradiated on an object to be machined is moved on the object to be machined when the direction and position of the laser beam irradiating device are moved with a multiple joint robot. In the preferable embodiment, the object to be machined may be a structural body made of resin. The structural body made of resin, which becomes the object to be machined, may be a structural body made of resin in which a plurality of parts are partially melted by laser beams so that they can be joined to each other. An example of the structural body made of resin is a housing made of resin. For example, the housing made of resin is composed of a plurality of parts such as a main body container portion and a cover portion, and these parts are partially melted to each other so that they can be joined to each other. The present invention can be applied to the method for manufacturing the above housing made of resin. In the case where the aforementioned structural body made of resin is irradiated with laser beams, the irradiating route, which is an irradiating locus, curves and extends onto a plurality of faces of a polyhedron. As a result, a moving speed of the laser irradiating point in the irradiating locus tends to change. The moving speed of the laser beam irradiating point can be obtained by a means for detecting and measuring a laser beam irradiating point or a movement of the multiple joint robot. Alternatively, the moving speed of the laser beam irradiating point can be obtained by a means for detecting a signal to control a motion of a multiple-joint robot for moving a laser beam irradiating point. In the embodiment described above, there is provided an adjusting means for proportionally adjusting an intensity of energy of laser beams according to the moving speed of the laser beam irradiating point. This adjusting means is operated in such a manner that an intensity of energy of laser beams is relatively increased when the moving speed of the laser beam irradiating point is relatively increased, and an intensity of energy of laser beams is relatively decreased when the moving speed of the laser beam irradiating point is relatively decreased. By this proportional characteristic, the resin melting joint characteristics such as a quantity of the melted resin in the irradiating locus, a depth of the melted resin and a size of the melted mark can be made substantially constant all over the length of the irradiating locus.

While the invention has been described by reference to specific embodiments chosen for purposes of illustration, it should be apparent that numerous modifications could be made thereto, by those skilled in the art, without departing from the basic concept and scope of the invention.

1. A laser beam machining method for machining a workpiece of a three-dimensional shape by irradiating laser beams with a movement of a robot, in which a locus speed of the robot at a position where the workpiece is machined is measured previously or in real time and the output of the laser beams is controlled according to the locus speed.

2. A laser beam machining method according to claim 1, wherein the workpiece is a resin product and the machining is weld machining.

3. A laser beam machining method according to claim 2, wherein a change in the transmission of the resin product with respect to laser beams can be fed back to an output of the laser beams.

4. A method for manufacturing a structural body of resin in which laser beams are irradiated along an irradiation locus, on a surface of the structural body of resin, so as to partially melt the structural body of resin and then the structural body of resin is hardened again, in which an output of the laser beams is proportionally controlled according to a locus speed of the laser beams.
